(19) United States
(12) Patent Application Publication
(10) Pub. No.: US 2003/0059078 A1
(43) Pub. Date: Mar. 27, 2003

(54) Directional sensors for head-mounted contact microphones

(76) Inventors: Edward F. Downs JR., Lynn Howen, FL (US); C. Dean Preston, Mary Esther, FL (US)

Correspondence Address: HELLER EHRMAN WHITE & MCAULIFFE LLP, SUITE 300, 101 ORCHARD RIDGE DR., GAITHERSBURG, MD, 20878-1917, US

(21) Appl. No.: 10/176,111

(22) Filed: Jun. 21, 2002

Related U.S. Application Data
(60) Provisional application No. 60/299,450, filed on Jun. 21, 2001.
(60) Provisional application No. 60/350,342, filed on Jan. 24, 2002.
(60) Provisional application No. 60/371,117, filed on Apr. 10, 2002.

(51) Int. Cl. H04R 25/00

(52) U.S. Cl. 381/381

(57) ABSTRACT

Directional piezoelectric devices and methods for their manufacture are provided that improve the quality of piezoelectric device mediated signal detection and provide new thermal imaging devices. The devices can provide over an order of magnitude improved signal to noise ratio compared with previously known devices. The devices may be used along with new head mounted acoustic technologies for improved voice communication systems in inherently noisy environments. The head mounted technologies utilize microphones that are activated by pressure wherein the applied trigger pressure further serves to improve efficiency of the microphones. Also provided are head pieces that include both microphones and speakers that are particularly useful for harsh environments such as those encountered by fire fighters. The head pieces are capable of further functions related to contact with the head of the user, such as reporting physiological variables of the user, along with oral communications.

### REFERENCE TO RELATED APPLICATIONS

This application claims priority to U.S. provisional application entitled “Acoustical Sensor” No. 60/299,450, filed Jun. 21, 2001, U.S. provisional application entitled “Acoustical Sensor and Method” No. 60/350,342, filed Jan. 24, 2002, and U.S. provisional application entitled “Head-Mounted Contact Microphone” No. 60/371,117, filed Apr. 10, 2002.

### BACKGROUND

1. Field of the Invention

This invention relates to the field of acoustical sensors and, in particular, to acoustical sensors that contact a solid medium that transmits sound.

2. Description of the Background

Acoustical sensors serve as transducers converting sound wave energy into electrical signals. Traditionally these sound waves reach the sensor by traveling through air. Sound waves may also travel through solid or liquid media. See for example, U.S. Pat. Nos. 5,652,566 and 6,072,921.

In some instances, sound traveling through one media is not readily transmitted through another, i.e. sound waves in air will reflect off a hard solid surface. In many of these instances, sound traveling through a solid is of more interest to the observer than sound transmitted through the air. Unfortunately, traditional sensors such as microphones are more suited to recording sound transmitted through air than through a solid. Such sensors are less suited for environments where a solid body vibration needs to be detected in the presence of strong air vibrations.

These sensor limitations are accentuated for applications that rely on bone conduction microphones for accurate voice communications, such as in hazardous, noisy environments traditionally encountered by fire, police and other emergency workers. In such instances a contact acoustical sensor may be placed in firm contact with the bones of the skull. This can be achieved by integrating the sensor within a piece of headgear, such as a hat band, and firmly tightening said head gear about the head. While this method can ensure firm contact it causes problems.

Headgear may be worn too tightly, causing user discomfort and possible performance degradation. A sensor may also elevate impact stresses locally in the event of a blow to the head. Integrating the sensor into the headgear may pose problems with regards to manufacturing as well as the need to have individual pieces of headgear dedicated to containing communications equipment.

A representative example of a previously known talk and listen headset designed for high noise environments is shown in U.S. Pat. No. 5,125,032 issued to Meister et al. on Jun. 23, 1992 and is particularly incorporated by reference in its entirety. This device uses a regular headband that positions on the top of the head and has a significant 3 dimensional structure, which prevents easy use in harsh environments. Furthermore the device is limited to low tension connection between microphone and the solid head surface. Accordingly, this, like many other devices has limited use in extreme environments. A talk and listen headset is needed that can function in dangerous areas where extreme environmental and noise conditions may occur.

The above problems with voice communications using contact microphones are made worse by acoustic sensors that do not discriminate vibrations from a solid surface from air borne vibrations, or worse, that are more sensitive to background noise transmitted through air. Thus the imperfect acoustic sensor problem particularly exacerbates the inherent difficulties facing reliable communications in situations where reliability often turns into a life or death dilemma. Accordingly, improvements in both acoustic sensors and methods of their use such as in headsets are needed, particularly in high noise environments.

### SUMMARY OF THE INVENTION

It has been surprisingly discovered that an acoustical sensor can be designed to alleviate the above cited concerns and that this design has many practical applications: As a microphone placed in contact with the bones of the skull for transmitting vocal sounds in high ambient noise environments to aid in recognition of said vocal sounds by human listeners or voice recognition software; as a microphone in the form listed above to eliminate the appearance of standard boom or lapel microphones for aesthetic or covert reasons; as a microphone placed in the canal of the outer ear for transmitting vocal sounds; as a sound transducer placed in contact with machinery or mechanical elements to allow for transmission of vibration signals for diagnostic purposes including fluid flow through or around mechanical elements, contact between moving elements, resonant vibration of elements or recording artificially induced vibrations, i.e. acoustic transmission testing for weld continuity; as a physiological monitor to listen to sounds generated or transmitted through the body, i.e. blood flow, heart sounds or reflectance or refraction of ultra high frequency sounds waves (ultrasound).

Some embodiments of the invention described herein concern an assembly using a contact acoustical sensor as a microphone for voice communications. The advantages of these embodiments over other possible contact microphones include the fact that the microphones may be attached and removed easily from a variety of head gear and that the devices employ the user pressing a push to talk switch to ensure firm contact of the microphone with the bones of the skull.

In many of these embodiments a contact acoustical sensor receives sounds transmitted through the skull and skin that contacts the sensor on one side and inherently discriminates against sounds traveling through the air. Such a device is very useful in transmitting voice sounds conducted through the bones of the skull while selecting against sounds conducted through the air outside the sensor, before any mechanical or electrical noise filtering. That is, these embodiments of the invention provide an extra dimension of noise filtering for yet improved noise resistance of contact acoustical sensors. Such a bone conduction system having 1) a contact acoustical sensor pickup that discriminates against noise from the air; 2) one or more mechanical shields to muffled unwanted exterior noise and 3) electrical noise filtering provides an unprecedented level of noise cancellation for use in harsh environments.

An embodiment of the invention described herein consists of a contact acoustical sensor designed to transmit an electrical signal generated by sound waves transmitted through a solid medium. A preferred embodiment of this device consists of a piezoelectric element with accompanying filtering and/or signal processing circuitry. Sound wave energy transmitted to this device will result in a corresponding electrical signal generated by the piezoelectric element. Embodiments of the invention provide contact acoustical sensors designed to transmit electrical signals generated by sound waves conducted through a solid medium. A preferred embodiment consists of a piezoelectric element with accompanying filtering and/or signal processing circuitry. Most particularly the contact acoustical sensor is used for voice communications, primarily by placing the sensor in firm contact with bones of the skull. Such a bone conduction microphone would allow transmission of voice signals from a person situated in a high ambient noise environment. In related embodiments the sensor is placed on other solids such as pipes, gear cases, or other body parts.

In a most advantageous embodiment the invention provides microphone communications from a user to another in harsh, demanding environments. In some embodiments the microphone is accompanied by a speaker. In other embodiments, particularly useful where information about the user's physiological status is important, one or more sensors may be included.

A particularly desirable embodiment is a contact microphone comprising a microphone and a push to talk switch that presses the microphone against a user such that sounds emanating from the user are effectively transmitted to the microphone. Another desirable embodiment is a thin talk/listen head piece for an adult user, comprising a flat material big enough to simultaneously cover the user's ear and the sagital arc anterior to the user's ear, a speaker within the flat material, a microphone within the flat material and located anterior to the speaker and a push to talk switch positioned above or near the microphone such that manual activation of the switch will exert pressure onto the microphone, increasing contact between the microphone and underlying skin.

Another embodiment is a unidirectional piezoelectric sensor produced by electrically connecting a surface from each of two polymeric piezoelectric acoustic elements to each other.

Yet another embodiment is a passive millimeter wave imager comprising a an electrically conductive surface coated piezoelectric device. In a related embodiment the device resonates at a specific frequency and the resonance causes the material to generate a signal. Other embodiments and advantages of the invention are set forth in part in the description which follows, and in part, will be obvious from this description, or may be learned from the practice of this invention.

### DESCRIPTION OF THE DRAWINGS

FIG. 1 A cross section diagram of an acoustical sensor according to an embodiment of the invention.

FIG. 2 A medial-lateral view of a sensor microphone positioned on a user's head, according to an embodiment of the invention.

FIG. 3 An anterior-posterior cross sectional view of the sensor microphone of FIG. 2.

### DESCRIPTION OF THE INVENTION

It has surprisingly been discovered that contact sensors can be built that provide inherent unidirectional discrimination against noise. Such sensors are useful in a wide range of applications, particularly where a sensor is located between two material phases. The unidirectional sensors were shown to favor vibrations traversing one (typically less dense) phase to another (typically more dense) phase over vibrations transiting the opposite direction. These sensors are applicable to a wide range of piezoelectric sensing where it is desired to favor reception of vibrations from one direction across a phase barrier (liquid to air; solid to air; solid to liquid) over the other phase. Space limitations preclude a listing of all possible applications for the new sensor, but the combined use of these sensors with new types of head mounted contact microphones, as discovered by the inventor are particularly desirable.

Problems exist with conventional head-mounted contact microphones that have been overcome with the new features of the invention. These features both improve the usability of such microphones and provide new attributes for more harsh environments where head mounted microphones are desired. When combined with the new contact sensor discovery, both the new sensor materials and their conformations in headwear provide particularly unexpected benefits in this field, as explained next.

Unidirectional Gain Sensors

A unidirectional gain sensor according to an embodiment of the invention is a planer (flat) piezo electric device that displays unbalanced sensitivity. That is, vibrations that enter the device from a side in contact with a denser phase of a phase boundary pair are detected more favorably compared to vibration energy that enters from the other side that contacts a lighter phase. An acoustic sensor device typically is formed as a sandwich with the surfaces of two adjacent thin film materials in contact with each other. The thin films preferably are polymer materials such as polyvinylidene fluoride (PVDF). Alternatively, a copolymer of polyvinylidene fluoride and a second polymer such as trifluoroethylene, tetrafluoroethylene and methylmethacrylate may be used which are known and described, for example in U.S. Pat. No. 5,024,872 issued to Wilson et al. on Jun. 18, 1991. The films generally are in the form of flexible sheets between 0.005 and 0.2 inches thick, preferably between 0.01 and 0.1 inches thick and more preferably between 0.015 and 0.05 inches thick, including an optional conductive material added to each of the two opposing planar surfaces.

A method for synthesis of the piezoelectric sheets in embodiments of the invention is to direct a sheet of polymer through a localized heated region of a processing machine to provide a localized heated portion and to stretch the sheet cross wise to create from the local heated region a “neck-down” region that propagates along unstretched portions. While the neck-down region is held in a heated region an electric field such as a corona discharge, is applied to polarize the film, as described in U.S. Pat. No. 5,024,872.

Unidirectional gain properties were identified by adding electrode surfaces and contacting the surfaces with each other in multi-element piezo arrays. In an embodiment a directional gain sensor for a variety of uses beyond head mounted communications are prepared by 1) heat deformation of a polymer followed by 2) application of an electric field to polarize the film 3) formation of electrode (electric conducting) surface on the sheet (which may be a metal film) and then 4) contact of at least two electrode coated surfaces with each other. In one embodiment, step 4 is carried out by wrapping one film around itself into a coil or roll. In another embodiment step four is carried out by wrapping a sandwich of at least two films around itself. In yet another embodiment step 4 is carried out by placing 2 or more flat sheets on top of each other.

In yet another embodiment a directional sensor is prepared by forming a cone, parabola or other three dimensional shape that intercepts vibrations from a point in space of a fluid or solid, or combination more readily than a flat sheet. In this latter embodiment the surface of the sensor comprises two or more layers of piezoelectric sheets held or bound together as described here. A non-planar construction provides desirable directionality and can be used in this context for both radio frequency and vibrational sensing. The devices are particularly useful in this context because they can respond to radiation or vibrations having much longer wavelength compared to the size of the sensor, and can be very compact. Thus, tiny devices such as in the ear devices are more easily constructed made due to the greater sensitivity of devices according to this embodiment of the invention. Antennas for a wide range of frequencies and applications are possible as well.

A three dimensional sensor may be formed by bending sheets of material, but in an embodiment the three dimensional structure is formed during manufacture by heating and stretching or otherwise forming the non-planar shape while hot, and treating with an electric field. In yet another embodiment two different types of non planar structures are made, one by application of an electric field in one direction across the material, the other by application of an electric field in the opposite direction across the material. The two non-planar shapes then are combined into a sandwich preferably by combining their like-treated surfaces in mutual contact (i.e. like polarized surfaces in contact). It was seen that application of the electric field can create a non-symmetrical change in the piezoelectric material such that one side is more sensitive to vibration than the other. Although either conformation is useful for different purposes, in a preferred embodiment the side of one film that is more sensitive to mechanical stimulus is placed in contact with the same more sensitive side of the other film, to form a sandwich with back to back orientation. In practice, the more sensitive side may be determined by measuring voltage from the piezoelectric device while mechanically striking either side with an object such as a finger, matchstick, metal rod or the like. The more sensitive side will generate a larger voltage spike in response to the stimulation than the less sensitive side.

In yet another embodiment the directional gain characteristics are further enhanced by increasing electric field energy normally used in the commercial process licensed by Raytheon by more than 25%, 50%, 100%, 200% and even more than 500%. In yet another embodiment at least three, four or more films are combined in a sandwich structure. In another embodiment, alternating layers are used wherein inner layers are made from film that has been more strongly treated by a higher electrostatic field during manufacturing compared to the outer layers. In yet another embodiment alternating layers are used wherein every other layer is thinner (less than half the thickness, not including any attached electrode) than the adjacent layers.

In yet another embodiment, a manufacturing procedure is provided wherein two polymeric piezoelectric sheets are prepared and formed into a sandwich, with like sides bound together. Preferably the like sides are bound via a third binding substance that is electrically conductive. Preferably an electrode lead is attached to the middle and another electrode at the outer surfaces to provide a signal from the sensor composite sandwich. In another embodiment, the two flat faces of each piezoelectric sheet are coated with a metal. The two sheets then are attached to each other before assembly into a sandwich. Preferably, electrodes are attached to the surfaces.

An electrode that is formed onto a surface of a piezoelectric film may comprise any of a variety of conducting materials, including for example copper film (preferred), aluminum film, silver, gold, a conductive plastic, conductive nickel, silver epoxy or the like. Two or more prepared films preferably are mechanically fastened with a substance such as conductive epoxy. The space between the conductors preferably is less than 0.01 inches, more preferably less than 0.005 inches, and yet more preferably less than 0.002 inches (determined as an average over the contact surface area). The conductive surface in many cases will be contacted with a conductive lead such as a copper wire for connection to a circuit.

Generally, after forming conductive surfaces, adding electric leads, and forming a sandwich, the directional gain sensor may be coated with a non-conductive protective layer such as conformal coating, or epoxy coating. For vibration sensing applications the device may be further coated with a conductive layer to block or alleviate absorption of radio frequency radiation. The conductive layer preferably is electrically attached to one or more outer conductive surfaces of the sandwich. For radio frequency sensing applications an outer conductive layer would not be used, to allow greater response. After the last layer has been added, another layer such as an epoxy may be further added for protection. In a desirable embodiment that uses the sensor as a contact microphone, the sensor is embedded into a soft silicone rubber to protect it and make it more comfortable when applied as a microphone to a body part.

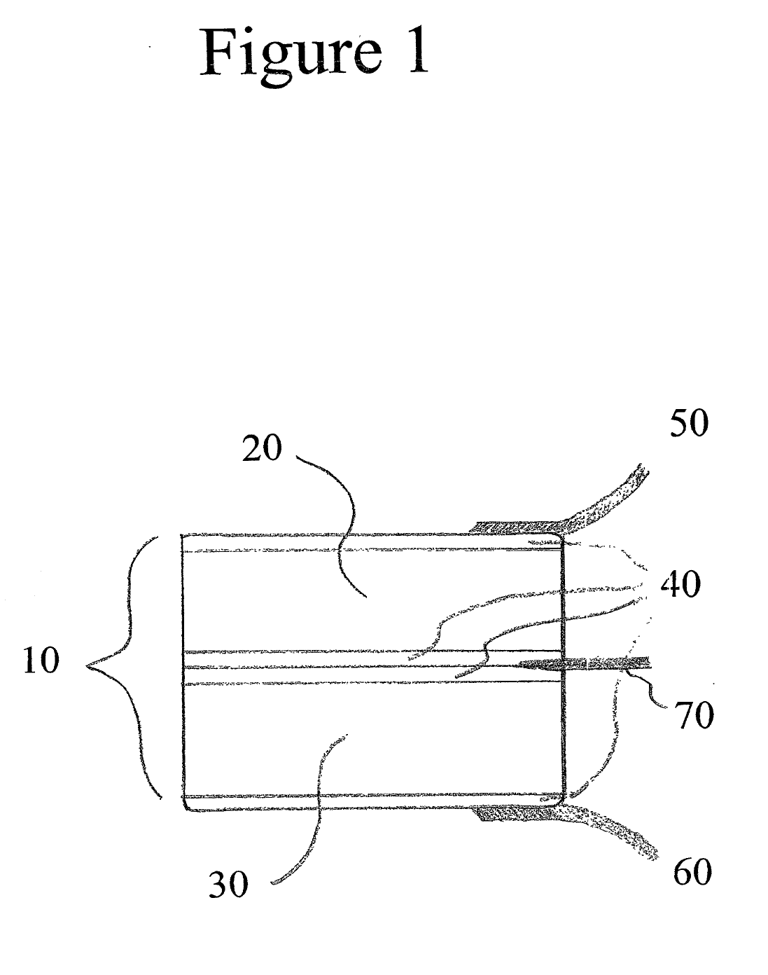

The individual piezoelectric elements that form a sandwich as described here may be electrically connected a variety of ways. In a preferred embodiment particularly useful for a conductive microphone a flat two element sandwich is prepared with the two piezoelectrically/mechanically more sensitive sides of the two elements facing into the center of the sandwich as shown in FIG. 1. Here, sandwich 10 comprises piezoelectric film layer 20 and piezoelectric film layer 30. Both film layers 20 and 30 are coated with conductive layers 40. Conductive layers 40 are electrically connected to outer leads 50 and inner leads 60. For more reproducible manufacture, a two step process was found to work well, wherein two adhesives are used having two different drying times. In a first step a bulk adhesive with a slow drying time is added to one or both piezoelectric sheets (or 3-dimensional shapes) to hold the majority of the surface areas in mutual contact. Then a fast drying adhesive is contacted with adjacent surfaces on the edges. The fast drying adhesive gives a quick tight bond that provides part stability for the slower drying adhesive. In an embodiment the bulk adhesive is an epoxy and the fast drying adhesive is a super glue.

In a preferred embodiment two PVDF piezoelectric films 0.021 inch thick (including copper film on both sides) are obtained from Airmar Technology Corporation, 35 Meadowbrook Drive, Milford, N.H., 03055. The more sensitive faces of each are glued together with conductive epoxy. The electrical leads from the two outside faces are connected together with a thin piece of copper tape that is 0.25 inches wide. A first signal wire attaches to the middle of the sandwich and a second signal wire attaches to the outside of the sandwich. The entire sandwich is covered with a non-conductive conformal coating. The sandwich then is coated with a thin conductive nickel epoxy. Shield leads from the attached signal wires attach to the conductive nickel epoxy. After drying, the transducer is coated with epoxy to protect it.

In desirable embodiments the leads from a sensor are electrically connected to a circuit and the signals buffered and amplified. Generally a high impendence input device such as a junction field effect transistor, is used to connect to the device. The input device may be a discrete device, or may be part of a larger semiconductor chip. The signals produced from the sensor thus are buffered, amplified and optionally analyzed further. One or more sensors may be used to obtain more detailed information. For example, a separate sensor may generate a background signal for comparison. Both signals may be input into a differential amplifier. In the case of a contact microphone for a high noise environment, one transducer may carry a voice signal and a second transducer may carry ambient noise, for electronic cancellation of the common noise component of the voice signal by the differential amplifier.

A sandwich sensor such as that shown in FIG. 1 preferably operates by contact with a surface of a more solid phase that contains sonic vibrations to be detected. For example, an object such as a head, gear case, airplane fuselage and the like may be contacted in air. The sensor may be used to contact a solid object in a fluid. In preferred embodiments the sensor preferentially will generate signals that correspond to vibration in the solid over vibration from the air or fluid, respectfully.

Passive and Active Millimeter Wave Frequency Imaging

Piezofilm materials and their uses were also discovered for inexpensive imaging. Desirably, passive millimeter wave frequencies are detected to form images. The technical specification sheets pertaining to piezopolymer published by Measurement Specialties, Fairfield, N.J. and found at http://www.msiusa.com/piezo/index.htm provide useful information related to this embodiment and are not included for brevity, but are incorporated specifically by reference in their entireties. Those specification sheets state that the piezofilm is sensitive up to 2 GHz. However in preferred embodiments passive millimeter wave imaging is carried out at higher frequencies by, what appears to be the effect of metal coating on piezoelectric assemblies. Such metal (or conductive material coated) antennas resonate at a specific frequency and the resonance causes the material to generate a signal.

In preferred imaging embodiments the antenna is in the shape of a bow tie or broken cross like a Nazi swastika. Such antennas can generate signals in the range of 10 to 300 gigahertz and preferably 30 to 200 gigahertz. Most preferably each pixel of the imager is a resonant antenna tuned to the desired frequency. Preferably at least 4, 9, 16, 25, 100, 1000 or more than 1,000,000 pixels are prepared and positioned in an array. In another embodiment thermal imaging devices are prepared and used, that rely on the pyroelectric properties of piezofilm. The technical specification sheets referenced above describe representative pyroelectric properties that are useful in many embodiments of the invention.

Head Mounted Contact Microphone

Head mounted contact microphones with piezoelectric sensors were developed to overcome the general problem of voice communication in noisy environments. Many previously known devices are generally limited to friendly environments in at least two aspects. One, many devices are designed to be held by a headband going over the top of the head. Two, the physical connection between a solid conducting microphone and the user's head, in many cases is not very high pressure, and not easily increased during the moments of need, when a user desires to communicate through the microphone. These and other problems could be alleviated with a head mounted contact microphone linked to a push to talk switch (PTT) at the immediate vicinity of the microphone itself. This allows the user to control the pressure variable for improved microphone performance in high noise environments.

A particularly useful feature of embodiments of the invention is a PTT switch that may be activated at the same time and at the same pressure point (within 2 inches, preferably within 1 inch, more preferably within 0.5 inch, most preferably right over) as the microphone. This feature accommodates the discovered problem, that improved microphone noise cancellation performance is achieved at the expense of discomfort. That is, exerting a high pressure upon the microphone at all times can be very unpleasant and even lead to headaches. The push to talk switch could be activated and, at the same time apply high pressure only for short time periods as needed for communication, thus maximizing pressure while minimizing overall discomfort. In further embodiments designed for harsh environments such as fire fighting, additional sensors may be added and a shock signal may be added for further communication of information to and from the user. In preferred embodiments the sensor shown in FIG. 1 is used to detect vibration from the skull.

Another useful feature of embodiments of the invention is positioning the talk and listen equipment as a thin continuous layer over at least one ear. It was discovered that by forming the speaker(s) and microphone(s) with a PTT switch as a thin layer many problems previously seen could be alleviated. A regular over the top head band such as that taught by U.S. Pat. No. 5,125,032 and which fits very poorly into a helmet or other protective head gear, is thereby avoided. In contrast, draping the thin continuous layer of the talk and listen device over a lateral headband allows use of the system in much more robust environments, such as those encountered by firefighters. Without wishing to be bound by any one theory of this embodiment of the invention, it is thought that the thin layer (less than 2 inches thick, preferably less than 1 inch thick, more preferably less than 0.75 inch thick, yet more preferably less than 0.5 inch thick, most preferably less than 0.25 inches thick) combined with attachment of the layer top to a lateral head band, the device body most easily avoids restricting movements of the wearer, while limiting shifting on the wearer's head. In an embodiment, a hard hat may be worn that partially covers the top of the ears and is particularly suitable. In yet another embodiment, the device is integrated into a hard hat that extends down below the ears. In this latter embodiment, a flexible indentation of the hard hat over the PTT may be provided, a cut out at this position may be provided, or a hole at this position may be provided.

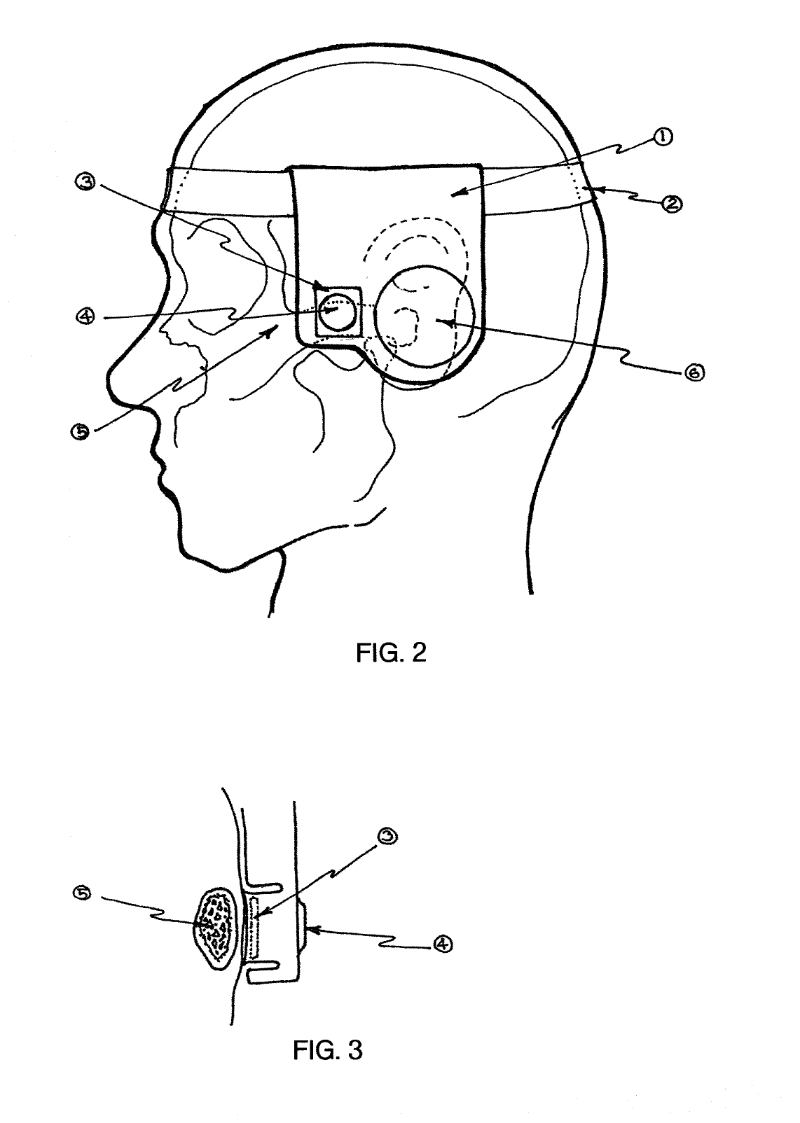

FIG. 2 illustrates features of desirable embodiments as a medial-lateral view of a users head with some bones of the skull shown as anatomical landmarks to aid in describing the positioning. A preferred embodiment of the invention housing (1) is shown in place. It is attached to a headband (2) by any of a number of simple hooks, snaps, buttons, clips or other means of attachment. This headband may also be part of another piece of headgear such as a hat or a helmet. In an embodiment the talk listen device is in a thin layer that is attached to a lateral headband and allows a hat or other protection to be worn that does not cover completely the ear.

The contact microphone (3) and PTT (4) are positioned directly over the zygomatic arch (5) with the PTT lateral to the microphone. This embodiment also houses a speaker (6) to allow two way communication. The housing is configured in conjunction with the means of attaching to the headband in such a manner that the microphone and speaker are positioned correctly with respect to the user's anatomy.

FIG. 3 is an anterior-posterior view of the users head in a sagital plane bisecting the zygomatic arch just anterior of the microphone. This figure serves to more clearly illustrate the relative positioning of the microphone, PTT and bones of the skull and the effect of the user's pushing the PTT, in one embodiment of the invention. Since firm contact of the microphone and the skull is essential for clear voice transmission, positioning the PTT immediately lateral to the microphone ensures that the user's pushing the PTT will also push the microphone against the skull.

In another embodiment the microphone is held off center from the PTT but is covered by one or more stiff materials that transmits at least some pressure exerted onto the PTT onto the microphone. In another embodiment the microphone is a thin plastic transducer such as that depicted in FIG. 1, that is deformable by the pressure exerted from the user. In another embodiment the microphone is attached to a deformable surface such as a plastic. The deformation is useful in some embodiments for greater acoustic conductivity, as a more uniform pressure is applied to the microphone surface that contacts the user's skin.

In yet another embodiment the PTT mechanism is part of a larger continuous stiff surface area that extends from at least above and covering the microphone to above and covering the speaker. This embodiment is particularly useful for allowing the user to listen more clearly when needed, as well as transmit more clearly, and is particularly useful for two channel systems that allow simultaneous talking and listening. In yet another embodiment, a head band is worn that covers the speaker and/or microphone so that the speaker and/or microphone remain in contact with the head even if the user has fallen or is inverted upside down. In yet another embodiment, the microphone circuit or transmitter (if used) of the device further includes a tilt detector to send a signal when the device is at an angle, indicating that the user has fallen.

In yet another embodiment the device further includes an accelerometer to indicate that the device (user wearing the device) has experienced a sudden movement, such as a lateral movement or a falling movement. In yet another embodiment the device further includes a temperature detector and generates a signal indicating relative or absolute temperature. In yet another embodiment, the device has a sensor at the point of applying pressure so that upon activating the PTT, the sensor detects blood pressure or heart beat, and reports such a physiological variable electronically. In yet another embodiment the device has a conductivity moisture detector at the point of contact, and electronically reports a relative or absolute rate of sweating by the user. These latter physiological sensors are particularly desirable when placed at or near the pressure point of contact between the PTT and the underlying skin.

In another embodiment the close skin contact of the device is exploited in particularly noisy and hazardous environments such as those encountered by firefighters by a signal shock feature. In this embodiment the device includes at least two conductive (typically metal probes) parts that touch the user's skin and through which an electrical signal may be sent to alert the user of a danger or to return from a hazardous location.

Embodiments as shown in FIGS. 2 and 3 advantageously hold one or more speakers directly over the user's ear(s) and thus assist reception of voice transmissions in high noise environments. This advantage can easily be enhanced by the addition of sound insulating and sealing materials in a manner similar to the earmuff style of hearing protectors. Sound insulating properties of the invention can also easily be augmented by the placing of the user's hand over the entire housing. This act will be easy and convenient to do as the user's hand will already be so positioned in order to operate the PTT. The embodiment shown also has the advantage of being easily used with protective gear or clothing such as gas masks, chemical protective suits or a fireman's Self Contained Breathing Apparatus.

In a preferred embodiment, a head mounted contact microphone with a push to talk switch located near to or over the microphone as described above is combined with a unidirectional acoustic sensor. The noise limiting feature of the head mounted contact microphone and the inherent noise limiting feature of the unidirectional sensor are additive and provide a more suitable microphone that either feature alone.

In advantageous embodiments a head mounted device that employs the unidirectional sensor to generate a voice signal further comprises a noise cancellation circuit. The noise cancellation circuit preferably includes a second sensor that generates a signal corresponding to environmental background noise transmitted through the air. The circuit compares the background signal with the voice signal and subtracts a background component of noise from the voice signal. Other desirable features include analog or digital filtering of frequencies that occur more often in background noise, and sound dampening material behind the transducer to reduce noise from entering the back of the element.

Other embodiments and advantages of the invention are set forth in part in the description which follows, and in part, will be obvious from this description, or may be learned from the practice of this invention. All documents cited herein including provisional application No. 60/299,450, filed Jun. 21, 2001, provisional application No. 60/350,342, filed Jan. 24, 2002, and provisional application No. 60/371,117, filed Apr. 10, 2002, are incorporated by reference in their entireties. U.S. Pat. Nos. 4,535,205; 4,696,045; 5,161,200; 5,024,872; 5,579,284; 5,889,871; 6,094,492; 6,104,816; and 6,347,147 specifically are each incorporated by reference herein in their entirety.

1. A unidirectional piezoelectric sensor comprising two piezoelectric acoustic elements, each element comprising two flat surfaces, a more sensitive surface and a less sensitive surface with respect to mechanical stimulation, wherein the sensor is produced by electrically and mechanically connecting a surface from each of the two polymeric piezoelectric acoustic elements to each other.

2. The sensor of claim 1, wherein the more sensitive surface of one piezoelectric acoustic element is in continuous electrical and mechanical contact with the more sensitive surface of the other piezoelectric acoustic element.

3. The sensor of claim 1, further comprising an electrically conductive surface on the flat surfaces of each element electrically connected to a lead, thereby forming two outer leads and two inner leads, wherein the two outer leads are connected to each other and the two inner leads are connected to each other.

4. The sensor of claim 1, wherein each polymeric piezoelectric element is flat.

5. The sensor of claim 1, wherein the surfaces of the two polymeric piezoelectric acoustic elements are electrically connected by a conductive epoxy.

6. The sensor of claim 1, wherein the surfaces of the two polymeric piezoelectric acoustic elements are coated with a metal.

7. The sensor of claim 1, produced by a process of heating a sheet of the polymeric material, stretching the heated portion, and polarizing the material with an electric field.

8. The sensor of claim 1, wherein the piezoelectric element comprises a metal.

9. The sensor of claim 1, wherein the piezoelectric element comprises a composite material.

10. The sensor of claim 1, further comprising a signal processing circuit that provides signal transmission.

11. The sensor of claim 1, further comprising a junction field effect transistor located in or on the sensor.

12. A contact microphone comprising the sensor of claim 1.

13. The microphone of claim 12, comprising a speaker device that transmits acoustical signals through bone and is placed in contact with the integument covering the bones of a skull or an outer ear canal.

14. The microphone of claim 12, further comprising a sound insulating material placed under the sensor or acoustical inputs, or the speaker device to allow for reception in high ambient noise environments.

15. The microphone of claim 12, further comprising voice recognition software.

16. The microphone of claim 12, further comprising noise cancellation circuitry.

17. The sensor of claim 1, which is placed in contact with a body for transmission of physiological sounds.

18. The sensor of claim 1, which is placed in contact with the body for transmission of acoustical signals induced artificially.

19. The sensor of claim 1, further comprising a mechanism for transmission of acoustical signals indicative of the operation of said mechanism.

20. The sensor of claim 1, further comprising a polymeric coating that protects against chemical agents.

21. A contact microphone, comprising a microphone and a push to talk switch that is capable of being pressed when the microphone is pressed against a user such that sounds emanating from the user are effectively transmitted to the microphone.

22. The microphone of claim 21, wherein the push to talk switch is capable of being pressed against said user adjacent to bones of the head.

23. The microphone of claim 21, which is attachable to clothing of said user.

24. The microphone of claim 21, which is reversibly attachable to head gear of said user.

25. The microphone of claim 21, which is positioned over the ear of said user.

26. The microphone of claim 21, further comprising a speaker that allows for two-way communications.

27. The microphone of claim 21, further comprising sound insulating materials placed about the microphone and a speaker to aid in communications in a high noise environment.

28. The microphone of claim 21, configured to allow for covert communications.

29. The microphone of claim 21, configured to allow for use in conjunction with protective gear, clothing, or equipment.

30. The microphone of claim 21, further comprising a noise cancellation circuit.

31. A method for detecting sound with the microphone of claim 21 comprising pushing the push to talk switch which presses the microphone against the user's body such that desired sounds emanating from the user are effectively transmitted to the microphone.

32. A thin talk/listen head piece for an adult user comprising:
a flat material that simultaneously cover the user's ear and the sagital arc anterior to the user's ear;
a speaker within the flat material;
a microphone within the flat material and located anterior to the speaker; and
a push to talk switch positioned above or near the microphone such that manual activation of the switch will exert pressure onto the microphone, increasing contact pressure or forces between the microphone and underlying skin.

33. The head piece of claim 32, further comprising a lateral head band, wherein the flat material has a maximum thickness of one inch and is attached at its upper edge to the lateral head band.

34. The head piece of claim 32, wherein the flat material is less than 0.5 inches thick.

35. The head piece of claim 32, further comprising at least one sensor selected from the group consisting of a tilt sensor, an acceleration detector, a position detector, a perspiration detector, a light detector, a light flash detector, a temperature detector, a blood pressure detector, a heart rate detector and a combination thereof.

36. The head piece of claim 33, wherein at least one sensor detects a physiological variable and is positioned between the push to talk switch and the user skin.

37. The head piece of claim 32, further comprising at least two conductive surfaces in contact with the user's body and a circuit that provides a signal shock to the user under control of an outside communication.

38. The head piece of claim 32, wherein the speaker is positioned over the ear of said user.

39. The head piece of claim 32, further comprising sound insulating materials placed about the microphone and a speaker to aid in communications in a high noise environment.
